(19) United States
(12) Patent Application Publication
(10) Pub. No.: US 2007/0002767 A1
(43) Pub. Date: Jan. 4, 2007

(54) Method and apparatus for device class discovery in a network

(76) Inventors: Jermel Kyon Holman, Austin, TX (US); Cuong T. Nguyen, Austin, TX (US)

Correspondence Address: HAMILTON & TERRILE, LLP, P.O. BOX 203518, AUSTIN, TX, 78720, US

(21) Appl. No.: 11/172,550

(22) Filed: Jun. 30, 2005

(51) Int. Cl. H04L 12/28

(52) U.S. Cl. 370/255

(57) ABSTRACT

A system and method for discovering a specific set, or class of, network devices based on predetermined criteria or attributes without performing a full network scan. The present invention uses network device classification information stored in the MAC address of Layer 3 and/or hybrid Layer 2/3 network devices to discover predetermined devices within a network faster than current approaches, while generating minimal network traffic.

### BACKGROUND OF THE INVENTION

1. Field of the Invention

The present invention relates in general to the field of information handling systems, and more specifically, to discovery of network devices within communication networks.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is processed, stored or communicated, an how quickly and efficiently the information may be processed, stored, or communicated. The variations in information handling systems allow for information handling systems to be general or configured for a specific user or specific use such as financial transaction processing, airline reservation, enterprise data storage, or global communications. In addition, information handling systems may include a variety of hardware and software components that may be configured to process, store, and communicate information, and may include one or more computer systems, data storage systems, and networking systems.

The hardware components and software applications that comprise information handling systems continue to improve in their ability to produce, manage and communicate information. One type of information handling system is a network switch, which may comprise a single node, or a group of nodes, within a computer network. For example, a single network switch may connect a group of servers to other devices in a network. As another example, multiple network switches may be interconnected in large, or geographically dispersed, network implementations to provide efficient device connectivity and/or advanced data routing capabilities between network nodes.

Interconnections between these network nodes are typically achieved by one or more physical links coupled to network switching devices comprised of a plurality of ports, each of which is capable of accepting a physical connection. As the number and complexity of computers, nodes, physical links, routers, and switching devices increase, network inventory management, administration, and troubleshooting can become complicated.

For example, new devices may need to be implemented within the network, or existing devices may need to be upgraded, requiring up-to-date information about the devices currently comprising the network, and how they are interconnected, in order to construct a network topology. In the past, constructing a network topology typically required a full or partial sweep of all possible network addresses within a network to locate active nodes. These full or partial network sweeps can add undesirable traffic and congestion to the network. Furthermore, discovery of devices comprising a network by their associated type, class, and/or attributes can present additional challenges. Currently, no efficient method exists for discovering a specific set, or class of, network devices based on their respective attributes, without performing a full network scan.

Those of skill in the art will be knowledgeable of the International Standards Organization's (ISO) Open System Interconnect (OSI) model, comprised of seven layers, for classifying information about computer network operation and management. While the switches, routers, computers and other devices that comprise a network may operate at one or more layers of the OSI model, Layers 2 and 3 are most pertinent to their discovery. Information about what devices comprise the network is generally called Layer 3 information, and information about how the devices are physically connected within the network is called Layer 2 information.

Layer 2 of the OSI model, known as the data link layer, generally involves data frame transfer within a network. Layer 2 switches operate at high speed, and can forward network traffic quickly based on the low-layer, physical network addressing information that is generally assigned to hardware devices during manufacture. However, Layer 2 switches possess little intelligence, and have no knowledge of a data packet's contents, nor its final destination.

Layer 3 of the OSI model, known as the network layer generally involves datagram routing from one network to another. A Layer 3 network device is defined as any resource capable of routing Internet Protocol (IP) network traffic. Layer 3 switches can examine network addresses more fully, to identify network locations as well as the physical destination device, understand the logical, address to which a packet is headed, and incorporate routing functions to calculate optimal routes. Even though Layer 3 processing takes more time than a simple Layer 2 look-up, potential delays can be overcome with hardware-based routing engines, and a high-throughput switching fabric.

A hybrid Layer 2/3 network device is defined as any resource capable of routing and forwarding Internet Protocol (IP) network traffic, and can include bridge, router, and switch hardware, as well as a client or server running forwarding and/or routing software. Layer 2/3 switches combine the speed of Layer 2 switching, with the intelligence of Layer 3 routing in a single platform, offering the advantages of both in one managed entity. Because Layer 2/3 devices do not read very deeply into the packet header, they can operate very efficiently while providing greater throughput.

Skilled practitioners ofthe art will understand that a managed classification system is the systematic grouping of information stored into categories based on defined associations or relationships. One example of a managed classification system would be the manner in which network vendors assign Media Access Controller (MAC) addresses to different types of network equipment (e.g., bridges, network interface cards (NICs), routers, switches, etc.). An example of information stored within a forwarding or routing device that could be applied towards a managed classification system is an Address Resolution Protocol (ARP) table, which is found in a Layer 3 or hybrid Layer 2/3 device, and contains IP address to MAC address associations. A MAC address is a numerical identifier, implemented on broadcast networks such as Ethernet, that uniquely identifies each network device and allows frames to be marked for routing to specific devices. As such, it forms much of the basis for Layer 2 networking, which higher OSI layer protocols build upon to produce complex, functioning networks.

For example, Layer 2 switches have several key functions, including MAC address learning, data frame forwarding, and making predetermined filtering decisions. When a Layer 2 switch is powered on, the MAC address table is initially empty. Whenever a frame is received, the switch caches the source address in the MAC address table, which is used thereafter to both forward and filter received frames. Likewise, Layer 2 switches can determine whether or not frames are transmitted via a specified port, resulting in the MAC address table also being referenced as a MAC filtering table.

Prior approaches for determining the actual physical topology of a network have used this MAC address capability to gather configuration information of a Layer 2 switch's neighboring network devices. However, as in full network scans, unnecessary or non-relevant devices are not filtered out to reduce the number of scanned devices. Other approaches combine MAC address information along with other information to aide the discovery of routers and switches. For example, BPDU, RARP, and other network protocol packets can be “sniffed” for additional device information and location. Similarly, information can be retrieved from bridge or router tables to construct a learned MAC address table.

However, none of these approaches have the ability to filter out unwanted or non-relevant devices based on the information gathered from their corresponding MAC addresses. What is needed, is an efficient method for discovering a specific set, or class of, network devices, based on predetermined attributes, without performing a full network scan.

### SUMMARY OF THE INVENTION

The present invention provides a system and method for discovering a specific set or class of network devices coupled to a network, based on predetermined criteria or attributes (e.g., manufacturer, set of devices, class of device, etc.) without performing a full network scan. Skilled practitioners of the art are aware that typical network scan approaches require a full or partial sweep of all possible IP addresses within a network to locate active nodes. These full or partial network sweeps can add undesirable traffic and congestion to the network.

The present invention uses the information stored within a Layer 3 network routing device, or a hybrid Layer 2/3 network forwarding and routing device, along with a managed classification system to optimize node-to-node network discovery. The device class network discovery method of the present invention can be implemented in any network application (e.g., network system management application). For example, in the present invention, a network system management application can obtain a “default gateway” (e.g., a Layer 3 or hybrid Layer 2/3 device).

The network system management application can then communicate with the Layer 3 or hybrid Layer 2/3 device and download a copy of the device's ARP and ipRouteTable via Simple Network Management Protocol (SNMP), Command Line Interface (CLI), or other network management protocol. The network system management application can then use the information from the downloaded ipRoute Table to discover all connected Layer 3 and hybrid Layer 2/3 devices, and thereafter can iteratively repeat the process until ARP and ipRouteTable tables have been downloaded for a plurality of Layer 3 and hybrid Layer 2/3 devices within the network.

The application can then apply a managed classification system to the downloaded ARP tables to obtain a subset of device(s) that meet the classification system criteria (e.g., all clients, peripheries, printers, routers, servers, switches, etc. manufactured by a set of predetermined suppliers). In one embodiment, the subset of devices can be obtained by filtering on the MAC address found in the ARP table to identify specific user-definable set of manufacturer devices or class of devices. In other embodiments, the filter can be used to compare the MAC with a list of user-defined MACs in an inventory database. The application can then directly contact the sub-set of devices meeting predetermined criteria established through the use of the managed classification system, and perform a deep or full discovery of those devices for system configuration, management, and/or monitoring purposes.

Use of this optimized discovery process reduces network traffic, and saves considerable time in discovering devices in a large network, by only communicating with the forwarding or routing devices, and the desired nodes. Furthermore, use of the invention allows enterprise applications to discover a predetermined set, or class of, devices comprising a network faster than current methods, while generating a fraction of the network traffic produced by current approaches. Those of skill in the art will understand that many such embodiments and variations of the invention are possible, including but not limited to those described hereinabove, which are by no means all inclusive.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized illustration of an information handling system that can be used to implement the method and apparatus of the present invention.

FIG. 2 illustrates the International Standards Organization's (ISO) Open System Interconnect (OSI) model.

FIG. 3 is a generalized illustration of an IP to MAC address association table, which depicts the relationship of the IP address 302 to the MAC, or physical, address of a network device.

FIG. 4 illustrates one embodiment of the present invention for discovering Layer 3 and hybrid Layer 2/3 network devices within a sub-network comprising a larger network.

FIG. 5 is a generalized illustration of one embodiment of the present invention as implemented for performing a deep or full discovery of Layer 3 and hybrid Layer 2/3 network devices with predetermined characteristics within a sub-network comprising a larger network.

FIG. 6 is a generalized illustration of one embodiment of the present invention, as implemented for performing a deep or full discovery of Layer 3 and hybrid Layer 2/3 network devices with predetermined characteristics, distributed across multiple sub-networks comprising a larger network.

FIG. 7 is a generalized illustration of one embodiment of the present invention, as implemented for discovering network devices attached to Layer 3 and/or hybrid Layer 2/3 devices with predetermined characteristics, distributed across multiple sub-networks comprising a larger network.

FIG. 8 is a generalized illustration of one embodiment of the present invention, as implemented for performing a deep or full discovery of network devices with matching, predetermined characteristics, attached to Layer 3 and/or hybrid Layer 2/3 devices distributed across multiple sub-networks comprising a larger network.

### DETAILED DESCRIPTION

The present invention provides a system and method for discovering a specific set, or class of, network devices (e.g., bridges, network interface cards, routers, switches, etc.) based on predetermined criteria or attributes without performing a full network scan. In one embodiment, the subset of devices can be obtained by filtering on the MAC address found in the ARP table to identify specific user-definable set of manufacturer devices or class of devices. In other embodiments, the filter can be used to compare the MAC with a list of user-defined MACs in an inventory database.

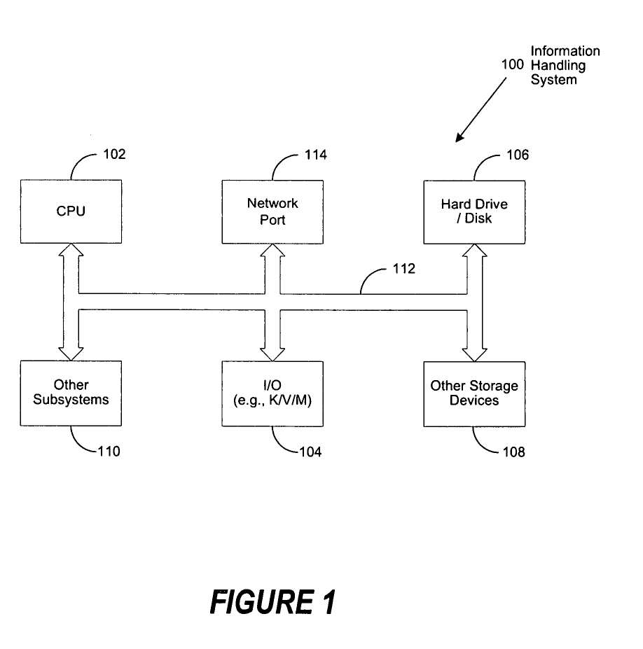

FIG. 1 is a generalized illustration of an information handling system 100 that can be used to implement the method and apparatus of the present invention. The information handling system includes a processor 102, input/output (I/O) devices 104, such as a display, a keyboard, a mouse, and associated controllers, a hard disk drive 106, other storage devices 108, such as a floppy disk and drive and other memory devices, various other subsystems 110, and network port 114, all interconnected via one or more buses 112.

For purposes of this disclosure, an information handling system may include any instrumentality or aggregate of instrumentalities operable to compute, classify, process, transmit, receive, retrieve, originate, store, display, manifest, detect, record, reproduce, handle, or utilize any form of information, intelligence or data for business, scientific, control or other purposes. For example an information handling system may be a personal computer, a network storage device, or any other suitable device and may vary in size, shape performance, functionality, and price. The information handling system may include random access memory (RAM), one or more processing resources such as a central processing unit (CPU) or hardware or software control logic, read only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components. Information handling systems may also comprise one or more nodes in a network and include, without limitation, individual devices such as network switches and server computers, as well as collections of other components and devices that cooperate to handle data.

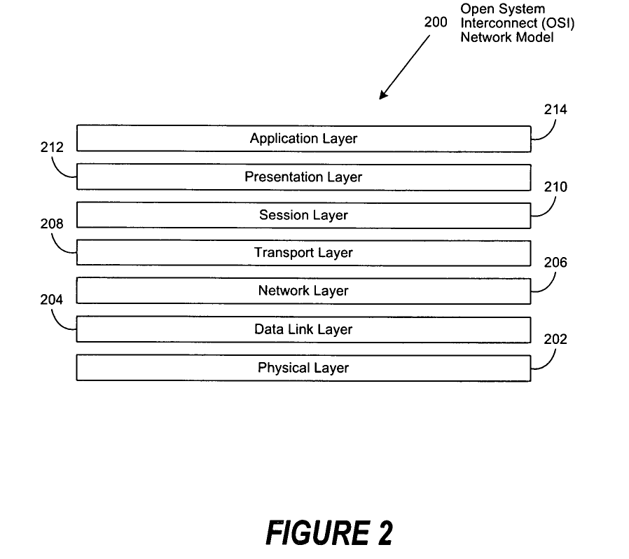

FIG. 2 is a generalized illustration of the International Standards Organization's (ISO) Open System Interconnect (OSI) model 200, comprised of seven layers, for classifying information about computer network operation and management. Layer 1, the Physical Layer 202, defines the physical medium such as cabling and interface specifications (e.g., AUI, 10Base-T, RJ45, etc.) for interconnecting network devices. Layer 2, the Data Link Layer 204, defines a lower layer addressing structure to be used between end systems as well as the lower layer framing and checksums used to transmit on the physical medium. Examples of Layer 2 protocols include Ethernet, Token Ring, and Frame Relay. Layer 3, the Network Layer 206, is concerned with the delivery of packets within a communications channel, and defines the addressing structure of the intemetwork and how packets should be routed between end systems. Layer 3 typically provides information about which Layer 4 protocol is being used, as well as local checksums to ensure data integrity. Internet Protocol (IP) and Internet Packet Exchange (IPX) are examples of Network Layer protocols. Layer 4, the Transport Layer 208, is responsible for providing an identifiable transport mechanism between two communicating devices. TCP, UDP, and ICMP are examples of Layer 4 protocols used to provide a delivery mechanism between network end-points. Layer 5, the Session Layer 210, is used by applications to tie together multiple Transport Layer session and provide synchronization between end devices. For example, the HTTP protocol can use multiple TCP connections to retrieve objects that make up a single Web page. Layer 6, the Presentation Layer 212, is used to provide a common way for applications to translate between data formats or perform encryption or decryption. Layer 7, the Application Layer 214, is where applications (e.g., browsers, email clients, etc.) reside. HTTP, FTP, SMTP and Telnet are all examples of Layer 7 protocols.

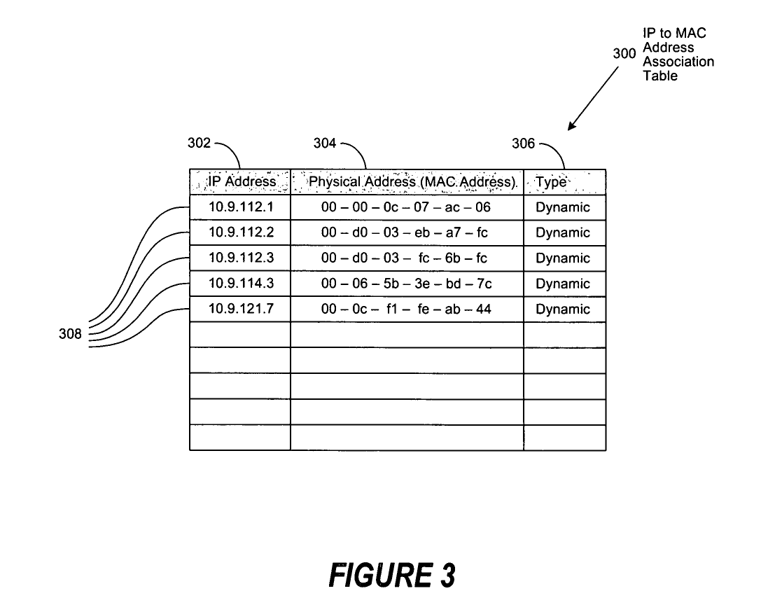

FIG. 3 is a generalized illustration of an IP to MAC address association table 300, which depicts the association of the IP address 302 to the MAC, or physical, address 304, along with an attribute (e.g., type, class, manufacturer, etc.) 306, of a predetermined network device 308. The IP to MAC address association table 300 can be generated by various methods of the present invention, and the illustration only depicts some of the information that might be displayed on a computer monitor or other device as an embodiment of the system of the invention.

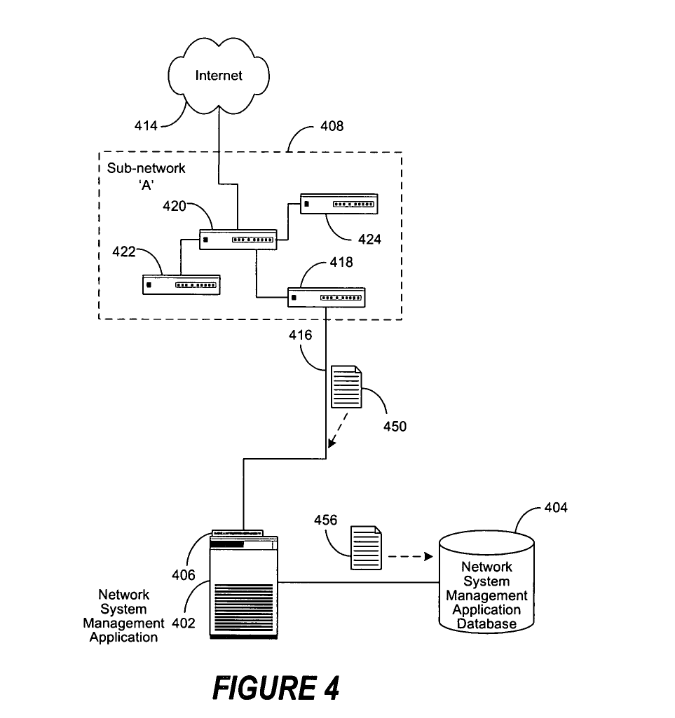

FIG. 4 is a generalized illustration of one embodiment of the present invention for discovering Layer 3 and hybrid Layer 2/3 network devices within a sub-network 408, comprising a larger network (e.g., the Internet) 414. In this embodiment of the invention, a method of the device class network algorithm can be implemented in any network application (e.g., network system management application 402), which can reside on an information processing system or other computing or control device.

In this same embodiment, the network system management application 402, communicating through a host network port 406, and a physical connection 416, can establish a default gateway, with a Layer 3 or hybrid Layer2/3 device (e.g., router) 418. Once the default gateway 418 is established, the network system management application 402 can then communicate with the gateway 418 and download a copy of the device's ARP and/or ipRouteTable tables 450 via Simple Network Management Protocol (SNMP), Command Line Interface (CLI), or some other management network protocol.

The network system management application 402 can then use the information from the downloaded ipRouteTable to to discover all connected Layer 3 and hybrid Layer 2/3 devices 420, 422, 424, and then iteratively repeat the process until ARP and ipRouteTable tables 450 have been downloaded for all Layer 3 and hybrid Layer 2/3 devices within the sub-network 408. Once downloaded, the network system management application 402 can store each discovered device's ARP and/or ipRouteTable tables 456 in a network system management application database 404 for later use.

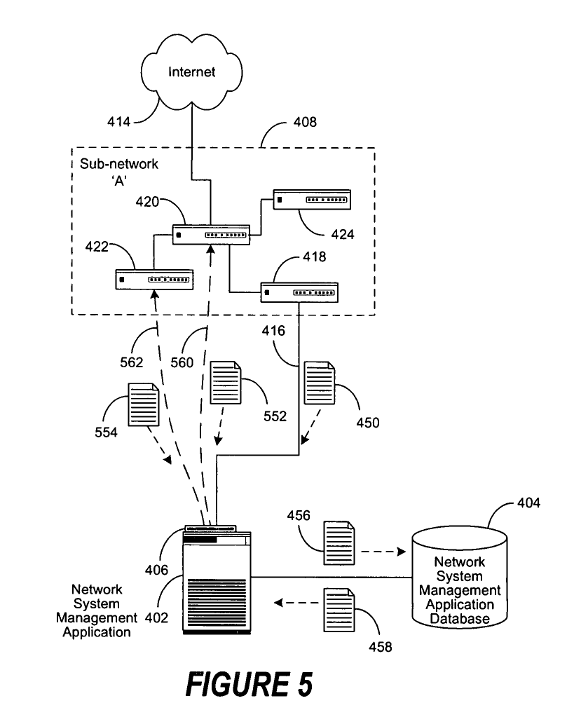

FIG. 5 is a generalized illustration of one embodiment of the present invention for performing a deep or full discovery of Layer 3 and hybrid Layer 2/3 network devices with predetermined characteristics within a sub-network 408, comprising a larger network (e.g., the Internet) 414. In this embodiment of the invention, the network system management application 402 can apply a managed classification system (e.g., filtering on the MAC address) found in the ARP and/or ipRouteTable tables 456 stored network system management application database 404, to identify a predetermined set or class of devices 458 that meet the classification system criteria (e.g., all routers, servers, switches, etc. manufactured by a predetermined manufacturer). The network system management application 402 can then directly contact 560, 562 the sub-set of Layer 3 and hybrid Layer 2/3 devices 420, 422 meeting the predetermined criteria 458 established through the use of the managed classification system, and perform a deep or full discovery of those devices, retrieving their respective and associated information 552, 554 for system configuration, management, and/or monitoring purposes.

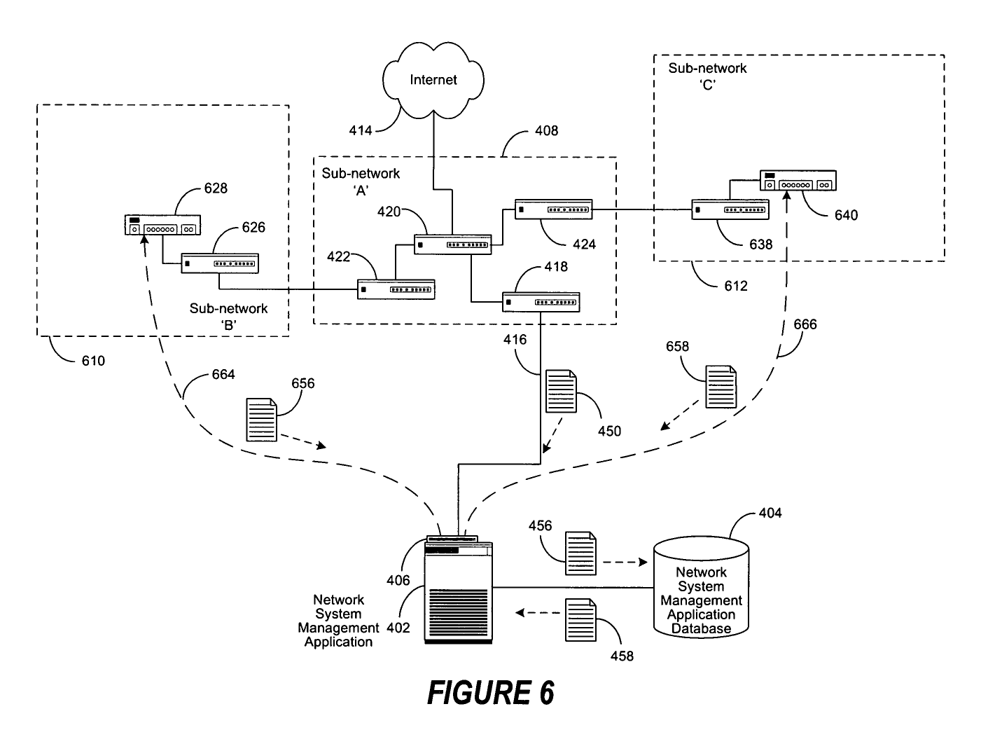

FIG. 6 is a generalized illustration of one embodiment of the present invention for performing a deep or full discovery of Layer 3 and hybrid Layer 2/3 network devices with predetermined characteristics distributed across multiple sub-networks 408, 610, 612 comprising a larger network (e.g., the Internet) 414. In this embodiment of the invention, once the default gateway 418 is established, the network system management application 402 can communicate with the gateway 418 and download a copy of the device's ARP and/or ipRouteTable tables 450. The network system management application 402 can then use the information from the downloaded ipRouteTable to to discover all connected Layer 3 and hybrid Layer 2/3 devices 420, 422, 424, within sub-network ‘A’ 408, and then iteratively download their associated ARP and ipRouteTable tables 450.

The network system management application 402 can repeat the process for sub-network ‘B’ 610 to discover all connected Layer 3 and hybrid Layer 2/3 devices 628, 630 and then iteratively download their associated ARP and ipRouteTable tables 450. Similarly, the network system management application 402 can then repeat the process for sub-network ‘C’ 612 to discover all connected Layer 3 and hybrid Layer 2/3 devices 638, 640 and then iteratively download their associated ARP and ipRouteTable tables 450. Once downloaded, the network system management application 402 can store each discovered device's ARP and/or ipRouteTable tables 456 in a network system management application database 404.

The network system management application 402 can then directly contact 664, 666 the sub-set of devices 628, 640 meeting the predetermined criteria 458 established through the use of the managed classification system, and perform a deep or full discovery of those devices, retrieving their respective and associated information 656, 658 for system configuration, management, and/or monitoring purposes.

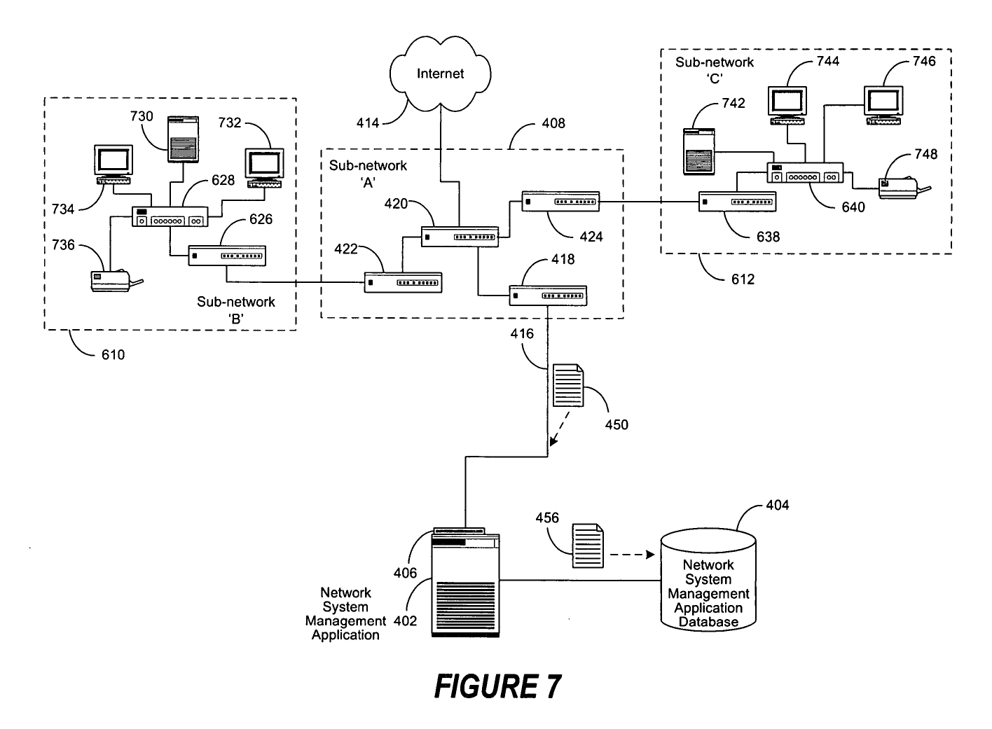

FIG. 7 is a generalized illustration of one embodiment of the present invention for discovering network devices, attached to Layer 3 and/or hybrid Layer 2/3 devices with predetermined characteristics, distributed across multiple sub-networks 408, 610, 612 comprising a larger network (e.g., the Internet) 414. In this embodiment of the invention, once the default gateway 418 is established, the network system management application 402 can communicate with the gateway 418 and download a copy of the device's ARP and/or ipRouteTable tables 450. The network system management application 402 can then use the information from the downloaded ipRouteTable to to discover all connected Layer 3 and hybrid Layer 2/3 devices 420, 422, 424, within sub-network ‘A’ 408, and then iteratively download their associated ARP and ipRouteTable tables 450. The network system management application 402 can repeat the process for sub-network ‘B’ 610 to discover all network devices 730, 732, 734, 736 connected to Layer 3 and/or hybrid Layer 2/3 device 630 and then iteratively download their associated ARP and ipRouteTable tables 450.

Similarly, the network system management application 402 can then repeat the process for sub-network ‘C’ 612 to discover all network devices 742, 744, 746, 748 connected to Layer 3 and/or hybrid Layer 2/3 device 640 and then iteratively download their associated ARP and ipRouteTable tables 450. Once downloaded, the network system management application 402 can store the ARP and/or ipRouteTable tables 456 in a network system management application database 404 for later use.

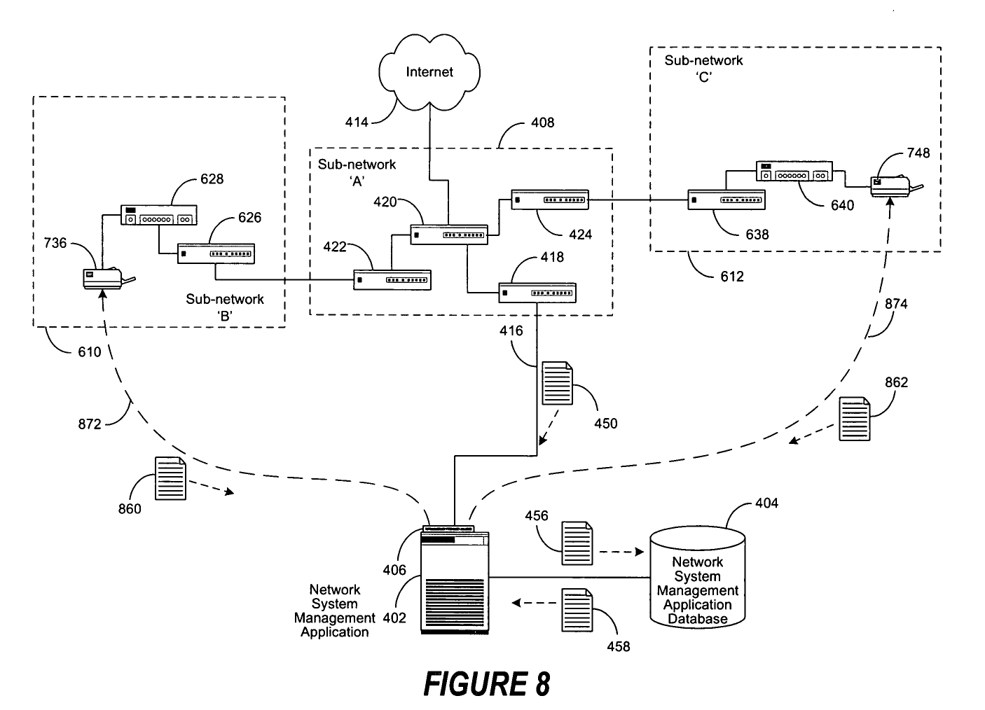

FIG. 8 is a generalized illustration of another embodiment of the present invention for performing a deep or full discovery of network devices with matching, predetermined characteristics, attached to Layer 3 and/or hybrid Layer 2/3 devices distributed across multiple sub-networks 408, 610, 612 comprising a larger network (e.g., the Internet) 414. In this embodiment of the invention, network devices attached to Layer 3 and hybrid Layer 2/3 devices, distributed across multiple sub-networks 408, 610, 612 comprising a larger network (e.g., the Internet) 414, have already been discovered and the ARP and/or ipRouteTable tables 456 of the Layer 3 and hybrid Layer 2/3 devices they are attached to have already been downloaded and stored in a network system management application database 404.

The network system management application 402 can apply a managed classification system (e.g., filtering on the MAC address) found in the ARP and/or ipRouteTable tables 456 stored on the network system management application database 404, to identify a predetermined set or class of devices 458 that meet the classification system criteria (e.g., all clients, peripheries, printers, routers, servers, switches, etc. manufactured by a set of predetermined suppliers). The network system management application 402 can then directly contact 872, 874 the specific devices 736, 748 meeting the predetermined criteria 458 established through the use of the managed classification system, and perform a deep or full discovery of those devices, retrieving their respective and associated information 860, 862 for system configuration, management, and/or monitoring purposes.

As discussed herein, the present invention provides a system and method for quickly identifying and discovering a specific class or type of device(s) within a network, using only the information found in a Layer 3 and hybrid Layer 2/3 device. Furthermore, use of the invention could allow enterprise applications to discover a predetermined set, or class of, devices within a network faster than current methods, and generating a fraction of the network traffic produced by current approaches.

Currently, the only network device classification information utilized is MAC address information stored in a Layer 3 and hybrid Layer 2/3 device, which encodes manufacturing, and possibly device class, and/or family information. In the future, other classification information may be identified that can be used by the method of the device class network algorithm, in which case, the invention can be equally applicable.

Although the embodiments disclosed have been described in detail, skilled practitioners in the art will recognize that many other embodiments and variations of the present invention are possible. In addition, each of the referenced components in this embodiment of the invention may be comprised of a plurality of components, each interacting with the other in a distributed environment. Furthermore, a variety of changes, substitutions and/or alterations can be made to expand on the referenced embodiments of the invention, thereby extending the scale and reach of the system's implementation.

What is claimed is:

1. A system for discovering devices on a network, comprising:
a plurality of network devices operably connected to said network, each of said network devices comprising a respective network device connectivity data table;
a first information handling system operably coupled to said network and serving as a gateway to said network, said first information handling system comprising a gateway data table containing network connectivity data relating to said plurality of network devices; and
a second information handling system operably coupled to said first information handling system,
wherein said second information handling system is operable to receive a copy of said gateway data table from said first information handling system and to use said gateway data table to discover said plurality of network devices connected to said network and to identify a predetermined class of network devices with said plurality of network devices.

2. The system of claim 1, wherein said second information handling system is further operable to download said network device connectivity data tables from said respective network devices.

3. The system of claim 2, wherein said second information handling system is further operable to store said gateway data table and said network device connectivity data tables in a network system management database.

4. The system of claim 3, wherein said second information handling system is operable to process said gateway data table and said network device connectivity tables to identify said predetermined class of network devices.

5. The system of claim 4, wherein said second information processing system is further operable to use a managed classification protocol to establish direct contact with said predetermined class of network devices.

6. The system of claim 5, wherein said second information handling system is operable to use said direct contact to manage said predetermined class of network devices.

7. A method for discovering devices on a network, wherein said network comprises:
a plurality of network devices operably connected to said network, each of said network devices comprising a respective network device connectivity data table;
a first information handling system operably coupled to said network and serving as a gateway to said network, said first information handling system comprising a gateway data table containing network connectivity data relating to said plurality of network devices;
wherein the method comprises:
operably coupling a second information handling system to said first information handling system;
using said second information handling system to receive a copy of said gateway data table from said first information handling system;
using said gateway data table to discover said plurality of network devices connected to said network; and
identifying a predetermined class of network devices with said plurality of network devices.

8. The method of claim 7, wherein said second information handling system is further operable to download said network device connectivity data tables from said respective network devices.

9. The method of claim 8, wherein said second information handling system is further operable to store said gateway data table and said network device connectivity data tables in a network system management database.

10. The method of claim 9, wherein said second information handling system is operable to process said gateway data table and said network device connectivity tables to identify said predetermined class of network devices.

11. The method of claim 10, wherein said second information processing system is further operable to use a managed classification protocol to establish direct contact with said predetermined class of network devices.

12. The method of claim 11, wherein said second information handling system is operable to use said direct contact to manage said predetermined class of network devices.

13. A system for discovering devices on a network comprising first and second subnetworks, comprising:
a plurality of first network devices operably connected to said first subnetwork, each of said first network devices comprising a respective device connectivity data table;
a plurality of second network devices operably connected to said second subnetwork, each of said second network devices comprising a respective device connectivity data table;
a first information handling system operably coupled to said first subnetwork and serving as a gateway to said first subnetwork, said first information handling system comprising a gateway data table containing network connectivity data relating to said plurality of first network devices; and
a second information handling system operably coupled to said first information handling system;
wherein said second information handling system is operable to receive a copy of said gateway data table from said first information handling system and to use said gateway data table to discover said plurality of first network devices connected to said first network and to discover said plurality of second network devices connected to said second subnetwork; and
wherein said second information handling system is further operable to identify a predetermined class of network devices within said plurality of first network devices and said plurality of second network devices.

14. The system of claim 13, wherein said second information handling system is further operable to download said network device connectivity data tables from said plurality of first network devices and said plurality of second network devices.

15. The system of claim 14, wherein said second information handling system is further operable to store said gateway data table and said network device connectivity data tables in a network system management database.

16. The system of claim 17, wherein said second information handling system is operable to process said gateway data table and said network device connectivity tables to identify said predetermined class of network devices.

17. The system of claim 16, wherein said second information processing system is further operable to use a managed classification protocol to establish direct contact with said predetermined class of network devices.

18. The system of claim 17, wherein said second information handling system is operable to use said direct contact to manage said predetermined class of network devices.

19. A method for discovering devices on a network comprising first and second subnetworks, wherein said network comprises:
a plurality of first network devices operably connected to said first subnetwork, each of said first network devices comprising a respective device connectivity data table;
a plurality of second network devices operably connected to said second subnetwork, each of said second network devices comprising a respective device connectivity data table; and
a first information handling system operably coupled to said first subnetwork and serving as a gateway to said first subnetwork, said first information handling system comprising a gateway data table containing network connectivity data relating to said plurality of first network devices;
wherein the method comprises:
operably coupling a second information handling system to said first information handling system;
using said second information handling system to receive a copy of said gateway data table from said first information handling system;
using said gateway data table to discover said plurality of first network devices connected to said first network and to discover said plurality of second network devices connected to said second subnetwork; and
using said second information handling system to identify a predetermined class of network devices within said plurality of first network devices and said plurality of second network devices.

20. The method of claim 19, wherein said second information handling system is further operable to download said network device connectivity data tables from said plurality of first network devices and said plurality of second network devices.

21. The method of claim 20, wherein said second information handling system is further operable to store said gateway data table and said network device connectivity data tables in a network system management database.

22. The method of claim 21, wherein said second information handling system is operable to process said gateway data table and said network device connectivity tables to identify said predetermined class of network devices.

23. The method of claim 22, wherein said second information processing system is further operable to use a managed classification protocol to establish direct contact with said predetermined class of network devices.

24. The method of claim 23, wherein said second information handling system is operable to use said direct contact to manage said predetermined class of network devices.
